(19) United States
(12) Patent Application Publication
(10) Pub. No.: US 2025/0163995 A1
(43) Pub. Date: May 22, 2025

(54) CONNECTOR ASSEMBLY AND LANYARD LOOP HAVING THE SAME

(71) Applicant: CASTIP INDUSTRIAL CO., LTD., New Taipei (TW)

(72) Inventors: Kuo-Hsin Huang, New Taipei (TW); Kuo-Jung Huang, New Taipei (TW)

(21) Appl. No.: 18/598,314

(22) Filed: Mar. 7, 2024

(30) Foreign Application Priority Data
Nov. 22, 2023 (TW) 112212689

(51) Int. Cl. F16G 11/10

(52) U.S. Cl. CPC F16G 11/10

(57) ABSTRACT

A connector assembly includes a female connector, a male connector, and an engaging member. The female connector is formed with an insertion slot and includes an inner peripheral surface surrounding the insertion slot. The male connector includes an insertion section for insertion into the insertion slot. The insertion section has an outer peripheral surface for facing the inner peripheral surface when the insertion section is inserted into the insertion slot. One of the inner peripheral surface and the outer peripheral surface is formed with an annular engaging groove, and the engaging member is disposed on the other one of the inner and outer peripheral surfaces. When the insertion section is inserted into the insertion slot, the engaging member is engaged in the annular engaging groove to fix the insertion section into the insertion slot.

### CROSS-REFERENCE TO RELATED APPLICATION

This application claims priority to Taiwanese Utility Model Patent Application No. 112212689, filed on Nov. 22, 2023, the entire disclosure of which is incorporated by reference herein.

### FIELD

The disclosure relates to a connector assembly and a lanyard loop having the connector assembly, and more particularly to a connector assembly for connecting a connecting wire and a lanyard loop having the connector assembly.

### BACKGROUND

A lanyard loop includes a connecting wire, and a connector that connects two opposite ends of the connecting wire. The connecting wire is generally a steel rope for hanging heavy objects, such as heavy tools, to a suitable place. The connector prevents the two opposing ends of the connecting wire from being loosened due to weights of the tools. However, most of conventional connectors are complicated in structure and costly. Furthermore, assembly of the conventional connector is inconvenient, thereby being unlikely to meet rapid assembly requirements.

### SUMMARY

Therefore, one object of the disclosure is to provide a connector assembly that can alleviate at least one of the drawbacks of the prior art.

Accordingly, the connector assembly includes a female connector and a male connector.

The female connector is formed with an insertion slot. The female connector includes an inner peripheral surface surrounding the insertion slot.

The male connector includes an insertion section for insertion into the insertion slot of the female connector. The insertion section has an outer peripheral surface for facing the inner peripheral surface when the insertion section of the male connector is inserted into the insertion slot of the female connector.

One of the inner peripheral surface of the female connector and the outer peripheral surface of the male connector is formed with an annular engaging groove. The connector assembly further includes an engaging member disposed on the other one of the inner peripheral surface and the outer peripheral surface.

When the insertion section is inserted into the insertion slot, the engaging member is engaged in the annular engaging groove to fix the insertion section into the insertion slot.

Another object of the disclosure is to provide a lanyard loop that includes a connecting wire and the abovementioned connector assembly. The female connector and the male connector are respectively connected to two ends of the connecting wire.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating an embodiment of a lanyard loop according to the disclosure.

FIG. 2 is a perspective view of the embodiment illustrating a male connector inserted into a female connector of a connector assembly to form a lanyard loop in a loop configuration.

FIG. 3 is a fragmentary exploded perspective view of the embodiment, illustrating an engaging member and the female connector of the connector assembly.

FIG. 4 is a fragmentary sectional view of the embodiment, illustrating the engaging member being assembled to the female connector.

FIG. 5 is a side view of the embodiment, illustrating the male connector being inserted into the female connector.

FIG. 6 is a fragmentary sectional view taken along line VI-VI in FIG. 5.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

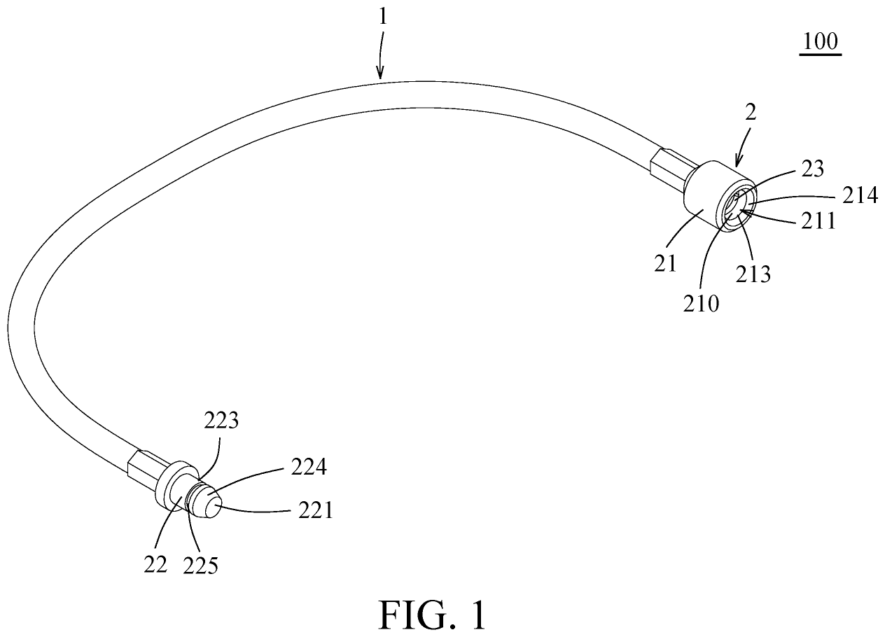

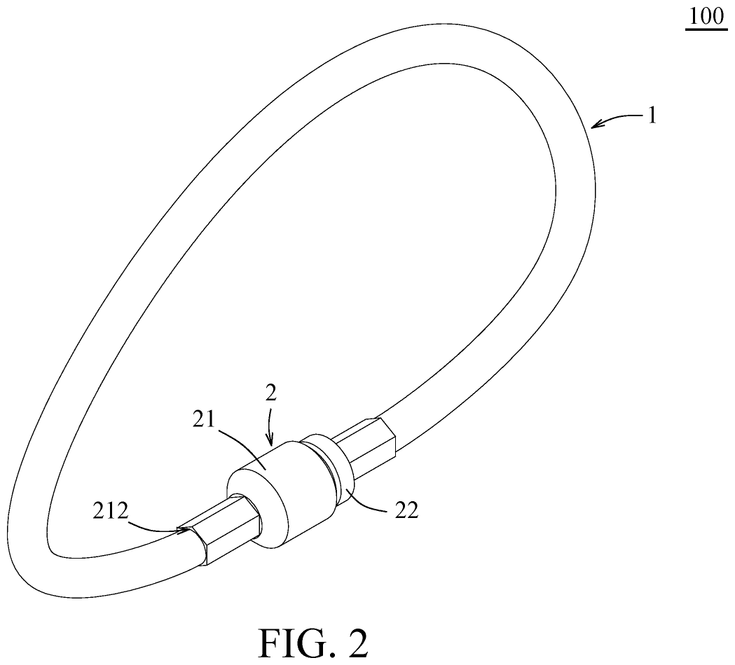

Referring to FIGS. 1 and 2, an embodiment of a lanyard loop 100 according to the disclosure is adapted to hang or connect an object (e.g. a tool), and includes a connecting wire 1 and a connector assembly 2. Herein, the connecting wire 1 is exemplified as a steel wire. The connector assembly 2 is configured to connect two ends of the connecting wire 1 so that the connecting wire 1 can form a loop after the two ends of the connecting wire 1 are connected (as shown in FIG. 2).

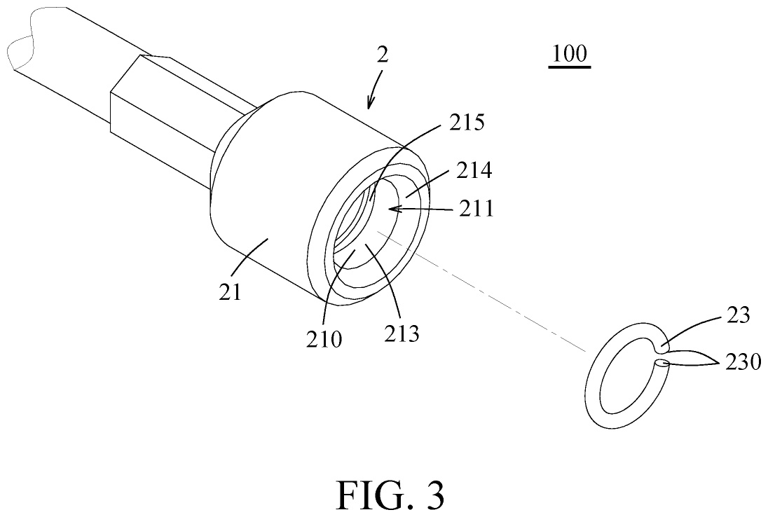

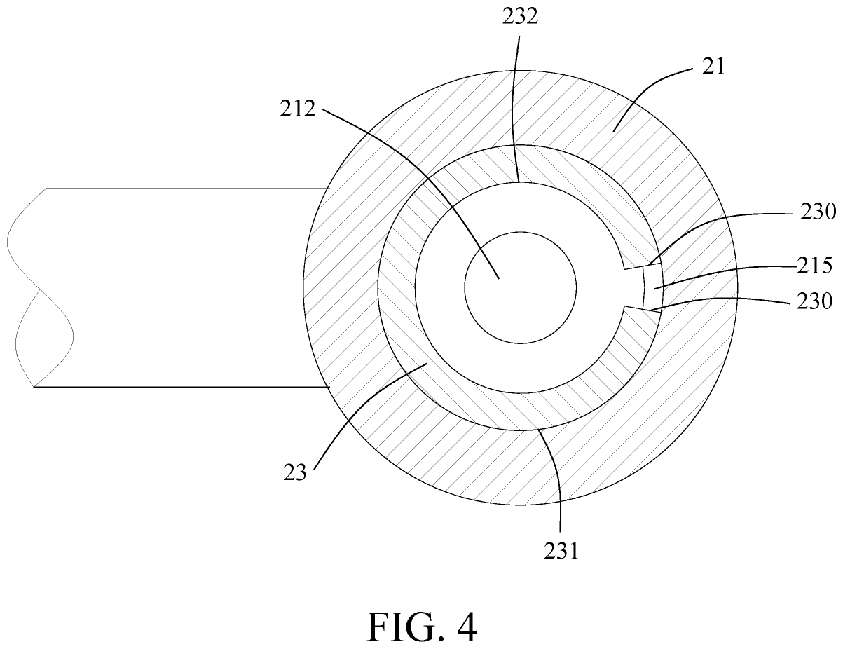

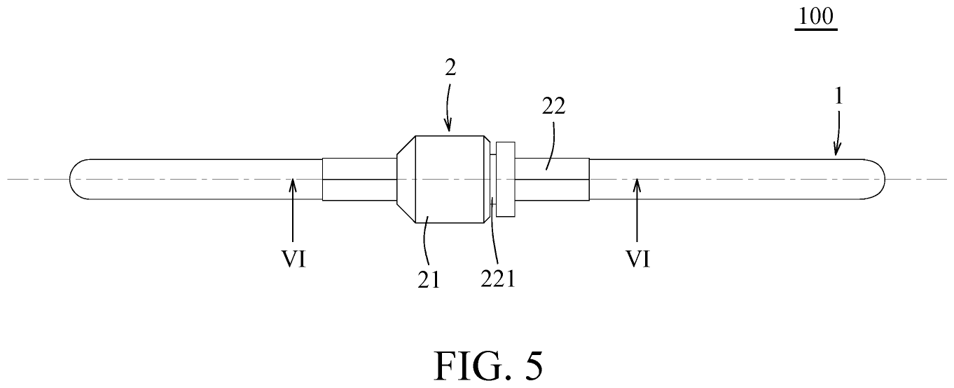

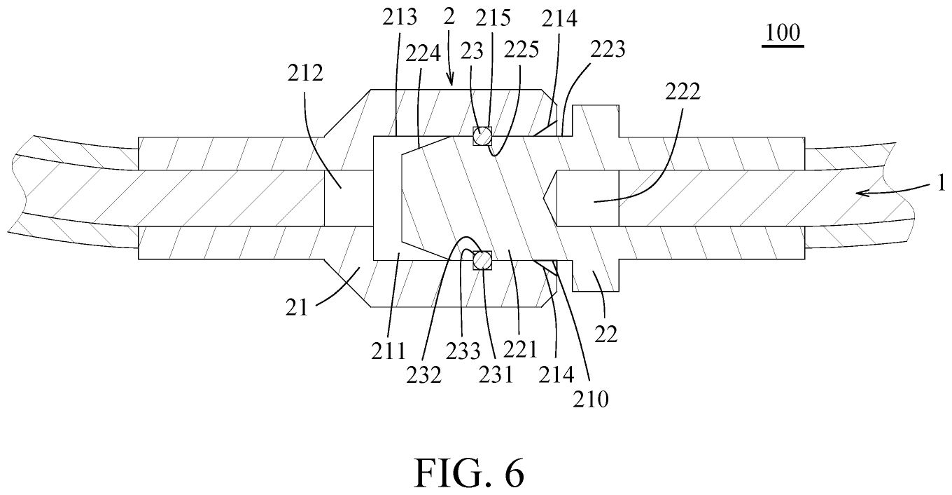

Referring to FIGS. 3 to 6, the connector assembly 2 includes a female connector 21, a male connector 22, and an engaging member 23.

The female connector 21 is made of a metal material. The female connector 21 is formed with an insertion slot 211 for insertion of the male connector 22 therein, and a first wire mounting hole 212. The insertion slot 211 has an opening 210. The first wire mounting hole 212 communicates with an end of the insertion slot 211 opposite to the opening 210, and is mounted with one of the two ends of the connecting wire 1. In this embodiment, a diameter of the first wire mounting hole 212 is smaller than a diameter of the insertion slot 211. The female connector 21 includes an inner peripheral surface 213 and a chamfered surface 214. The inner peripheral surface 213 surrounds the insertion slot 211. The inner peripheral surface 213 is formed with an annular retaining groove 215 indented radially and outwardly and communicating with the insertion slot 211. The annular retaining groove 215 is configured to allow installation of the engaging member 23. The chamfered surface 214 is connected to an end of the inner peripheral surface 213, and is adjacent to the opening 210 of the insertion slot 211. The chamfered surface 214 is disposed for contact with the male connector 22 to guide movement of the male connector 22 to the insertion slot 211.

The male connector 22 is made of a metal material. The male connector 22 includes an insertion section 221 for insertion into the insertion slot 211 of the female connector 21, and the male connector 22 is formed with a second wire mounting hole 222. The insertion section 221 has an outer peripheral surface 223 and a frusto-conical surface 224. The outer peripheral surface 223 is configured to face the inner peripheral surface 213 when the insertion section 221 of the male connector 22 is inserted into the insertion slot 211 of the female connector 21. The outer peripheral surface 223 is formed with an annular engaging groove 225 indented radially. The annular engaging groove 225 is used for engagement of the engaging member 23 The frusto-conical surface 224 is connected to an end of the outer peripheral surface 223 distal from the second wire mounting hole 222. After the engaging member 23 is installed in the annular retaining groove 215 and during insertion of the insertion section 221 into the insertion slot 211, the frusto-conical surface 224 contacts the engaging member 23 and expands the engaging member 23 until the annular engaging groove 225 is engaged with the engaging member 23. The second wire mounting hole 222 is mounted with the other one of the two ends of the connecting wire 1.

The engaging member 23 is a C-shaped elastic ring made of a metal material. The engaging member 23 is formed in a C-shaped configuration by bending a cylindrical metal wire. The engaging member 23 has two spaced-apart free ends 230. To install the engaging member 23 in the annular retaining groove 215 of the female connector 21, the engaging member 23 is first compressed to move the free ends 230 toward each other. At this time, the engaging member 23 is in a deformed state and accumulates an elastic force. Subsequently, the engaging member 23 is inserted into the insertion slot 211 through the opening 210. When the engaging member 23 is aligned with the annular retaining groove 215, the engaging member 23 is allowed to restore by the elastic force and partially engaged with the annular retaining groove 215. Such elastic force securely retains the engaging member 23 in the annular retaining groove 215.

The engaging member 23 has a retaining section 231 engaged within the annular retaining groove 215, and an engaging section 232 projecting from the inner peripheral surface 213 and engageable with the annular engaging groove 225 when the insertion section 221 is inserted into the insertion slot 211. The engaging section 232 has a semicircular arc surface 233 for contact with the frusto-conical surface 224 during insertion of the insertion section 221 into the insertion slot 211.

To assemble the male connector 22 to the female connector 21, the insertion section 221 of the male connector 22 is inserted into the insertion slot 211 through the opening 210. During the insertion of the insertion section 221 into the insertion slot 211, if a positional deviation of the male connector 22 causes the frusto-conical surface 224 to contact the chamfered surface 214, the chamfered surface 214 will guide the frusto-conical surface 224 to move toward the insertion slot 211, i.e., guide movement of the insertion section 221 into the insertion slot 211 through the opening 210. Through this, the positional deviation of the male connector 22 can be rectified during assembly, thereby enhancing convenience of assembly of the male connector 22.

During the movement of the insertion section 221 into the insertion slot 211, when the frusto-conical surface 224 contacts the semicircular arc surface 233 of the engaging section 232, a radially thrusting force applied by the frusto-conical surface 224 to the semicircular arc surface 233 expands the engaging member 23 such that the engaging member 23 is once again deformed and accumulates an elastic force. When the frusto-conical surface 224 moves past the engaging member 23 and the annular engaging groove 225 is aligned with the engaging member 23, the engaging member 23 is elastically restored due to the elastic force, so that the engaging section 232 can be automatically engaged within the annular engaging groove 225. By virtue of the engaging section 232 of the engaging member 23 engaging with the annular engaging groove 225, the insertion section 221 can be stably fixed in the insertion slot 211. At this time, assembly of the male connector 22 and the female connector 21 is completed.

Through the design of the semicircular arc surface 233 of the engaging section 232 for contact with the frusto-conical surface 224, during the insertion of the insertion section 221 into the insertion slot 211, the frusto-conical surface 224 can smoothly expand the engaging member 23. Through this, operative convenience of the male connector 22 during insertion and assembly can be enhanced.

Through the design of the annular engaging groove 225 being disposed in the male connector 22 and the engaging member 23 being disposed in the female connector 21, orientation of the insertion section 221 is not required to be adjusted before the insertion section 221 is inserted into the insertion slot 211, and the engaging member 23 can always be engaged with the annular engaging groove 225 after the insertion section 221 is inserted into the insertion slot 211. Through this, operation convenience of the male connector 22 during insertion and assembly can be enhanced. It should be noted that, in this embodiment, the engaging member 23 is assembled to the female connector 21 via engagement with the annular retaining groove 215. However, the engaging member 23 may be integrally formed on the inner peripheral surface 213. That is, the engaging member 23 has only the engaging section 232, and the engaging section 232 integrally and directly protrudes from the inner peripheral surface 213.

As aforementioned, in this embodiment, the annular engaging groove 225 is formed in the outer peripheral surface 223 of the male connector 22, and the engaging member 23 is disposed on the inner peripheral surface 213 of the female connector 21. Alternatively, in other embodiments, the engaging member 23 may be disposed on the outer peripheral surface 223, and the annular engaging groove 225 may be formed in the inner peripheral surface 213 for engaging the engaging member 23, so that the insertion section 221 can be stably fixed in the insertion slot 211.

In summary, the connector assembly 2 of the lanyard loop 100 includes the male connector 22 and the female connector 21 for insertion of the male connector 22. By virtue of the engaging member 23 being engageable with the annular engaging groove 225, the insertion section 221 of the male connector 22 can be directly inserted into the insertion slot 211 of the female connector 21 to form a loop without orientation adjustment before inserting the insertion section 221 into the insertion slot 211. Accordingly, the connector assembly 2 may be in a simple structure and be rapidly and conveniently assembled so as to meet requirements such as low cost and rapid assembly.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A connector assembly for a lanyard loop, comprising:
a female connector formed with an insertion slot, said female connector including an inner peripheral surface that surrounds said insertion slot; and
a male connector including an insertion section for insertion into said insertion slot of said female connector, said insertion section having an outer peripheral surface for facing said inner peripheral surface when said insertion section of said male connector is inserted into said insertion slot of said female connector;
wherein one of said inner peripheral surface of said female connector and said outer peripheral surface of said male connector is formed with an annular engaging groove;
wherein said connector assembly further comprises an engaging member disposed on the other one of said inner peripheral surface and said outer peripheral surface; and
wherein when said insertion section is inserted into said insertion slot, said engaging member is engaged in said annular engaging groove to fix said insertion section into said insertion slot.

2. The connector assembly as claimed in claim 1, wherein:
said engaging member is movably disposed on said inner peripheral surface of said female connector, and said outer peripheral surface of said male connector is formed with said annular engaging groove indented radially;
said insertion section further has a frusto-conical surface connected to said outer peripheral surface; and
during insertion of said insertion section into said insertion slot, said frusto-conical surface is configured to contact said engaging member and expand said engaging member until said annular engaging groove is engaged with said engaging member.

3. The connector assembly as claimed in claim 2, wherein:
said engaging member has an engaging section projecting from said inner peripheral surface and engageable with said annular engaging groove when said insertion section is inserted into said insertion slot; and
said engaging section has a semicircular arc surface for contact with said frusto-conical surface during the insertion of said insertion section into said insertion slot.

4. The connector assembly as claimed in claim 2, wherein:
said inner peripheral surface of said female connector is formed with an annular retaining groove indented radially and outwardly and communicating with said insertion slot; and
said engaging member has a retaining section engaged within said annular retaining groove, and an engaging section projecting from said inner peripheral surface and engageable with said annular engaging groove when said insertion section is inserted into said insertion slot.

5. The connector assembly as claimed in claim 2, wherein:
said inner peripheral surface of said female connector is formed with an annular retaining groove indented radially and outwardly and communicating with said insertion slot;
said engaging member is a C-shaped elastic ring; and
a part of said engaging member is engaged within said annular retaining groove, and another part of said engaging member projects from said inner peripheral surface.

6. The connector assembly as claimed in claim 5, wherein said engaging member is made of a metal material.

7. The connector assembly as claimed in claim 1, wherein:
said insertion slot has an opening;
said female connector includes a chamfered surface connected to said inner peripheral surface and adjacent to said opening; and
said chamfered surface is disposed for contact with said insertion section during the insertion of said insertion section into said insertion slot to guide movement of said insertion section into said insertion slot.

8. The connector assembly as claimed in claim 1, wherein said female connector is further formed with a first wire mounting hole, and said male connector is formed with a second wire mounting hole.

9. A lanyard loop, comprising:
a connecting wire; and
said connector assembly as claimed in claim 1;
wherein said female connector and said male connector are respectively connected to two ends of said connecting wire.

10. The lanyard loop as claimed in claim 9, wherein:
said engaging member is movably disposed on said inner peripheral surface of said female connector;
said outer peripheral surface of said male connector is formed with said annular engaging groove indented radially;
said insertion section further has a frusto-conical surface connected to said outer peripheral surface; and
during insertion of said insertion section into said insertion slot, said frusto-conical surface is configured to contact said engaging member and expand said engaging member until said annular engaging groove is engaged with said engaging member.

11. The lanyard loop as claimed in claim 10, wherein:
said engaging member has an engaging section projecting from said inner peripheral surface and engageable with said annular engaging groove when said insertion section is inserted into said insertion slot; and
said engaging section has a semicircular arc surface for contact with said frusto-conical surface during the insertion of said insertion section into said insertion slot.

12. The lanyard loop as claimed in claim 10, wherein:
said inner peripheral surface of said female connector is formed with an annular retaining groove indented radially and outwardly and communicating with said insertion slot; and
said engaging member has a retaining section engaged within said annular retaining groove, and an engaging section projecting from said inner peripheral surface and engageable with said annular engaging groove when said insertion section is inserted into said insertion slot.

13. The lanyard loop as claimed in claim 10, wherein:
said inner peripheral surface of said female connector is formed with an annular retaining groove indented radially and outwardly and communicating with said insertion slot;
said engaging member is a C-shaped elastic ring; and
a part of said engaging member is engaged within said annular retaining groove, and another part of said engaging member projects from said inner peripheral surface.

14. The lanyard loop as claimed in claim 13, wherein said engaging member is made of a metal material.

15. The lanyard loop as claimed in claim 9, wherein:
said insertion slot has an opening;
said female connector includes a chamfered surface connected to said inner peripheral surface and adjacent to said opening; and
said chamfered surface is disposed for contact with said insertion section during the insertion of said insertion section into said insertion slot to guide movement of said insertion section into said insertion slot.

16. The lanyard loop as claimed in claim 9, wherein said female connector is further formed with a first wire mounting hole mounted with one of said two ends of said connecting wire, and said male connector is formed with a second wire mounting hole mounted with the other one of said two ends of said connecting wire.
